(19) United States
(12) Patent Application Publication
(10) Pub. No.: US 2006/0183469 A1
(43) Pub. Date: Aug. 17, 2006

(54) Mobile communication device backup, disaster recovery, and migration scheme

(76) Inventor: Gregory P. Gadson, Noblesville, IN (US)

Correspondence Address: Gregory P. Gadson, Esq., 19375 Amber Way, Noblesville, IN, 46060, US

(21) Appl. No.: 11/058,980

(22) Filed: Feb. 16, 2005

(51) Int. Cl. H04M 3/00

(52) U.S. Cl. 455/419; 455/418

(57) ABSTRACT

In a multiple customer subscriber communication system, an information backup and transfer method for wireless, mobile communication devices at least includes: a) maintaining a user state database under the dominion of a control office; b) initiating a communication session at least between a mobile communication device and the central office, the communication session having the capability of at least one separate function from backup or transfer of user state information stored on the mobile communication device; and c) during the communication session established in element b), uploading and storing in the user state database, user state information stored on the mobile communication device. User state information is information which can be used to automatically recreate the look, feel and memory (e.g., personal telephone directory, calendars, games and game statuses) of aspects of one mobile communication device on another mobile communication device for situations such as when a cellular telephone customer changes to new telephone either by choice, or by necessity when a telephone is lost or damaged. The centrally stored user state can be migrated to the new mobile communication device and implemented by the new device so that the new device mimics at least a portion of the personalized operation of the old mobile communication device.

### BACKGROUND OF THE INVENTION

1. Field of the Invention

The present invention broadly relates to mobile and cellular communication devices and systems. More particularly, the present invention relates to the preservation and practical transfer of information locally stored on mobile communication devices.

2. Background

Cellular telephone systems are well known in the art, and minimally include an array of cell towers, each tower facilitating duplex communication of cellular telephone customers within a defined region called a “cell.” The switching and processing (including signaling and control) of calls within a cellular telephone system and between a Central Office (CO) of a Public Switched Telephone Network (PSTN), is handled by a Mobile Traffic Switching Office (MTSO).

Mobile communication device such as cellular telephones often have relatively short practical life spans. The reasons for such short life spans are numerous, including the practice of customers having to replace lost or damaged telephones, and the practice of “upgrading” to acquire newer models.

One major inconvenience in replacing mobile communication devices is that information stored on the old device is typically unable to be transferred to the new device. The aforementioned information includes directory information (telephone numbers, names, addresses, etc.) input by the user, and games and game status information, among others.

Also lost when changing to a new mobile communication device are the unique device settings that can be programmed by the user, including ring and listening volumes, specific type of ring (including ring patterns that may have been downloaded), display settings (including backgrounds, icons, etc. that may have been downloaded), and other data, applications, user settings, user preferences and audiovisual content (whether input directly by the user or downloaded). The aforementioned components collectively comprise a “user state.” That is, the user state is analogous to a comprehensive “snapshot” of a communication device which reveals the details needed to construct the current status of the device.

Even when a mobile communication device is not replaced, they can sometimes lose stored data, user settings and user preferences when the battery or other power source is dislodged or otherwise interrupted.

One prior art approach to migrating information from a cellular telephone is to load special software onto a computer (e.g., of the desktop variety), and then periodically connect the cellular telephone via a special cable to the computer to back up certain information stored on the telephone. The stored information can then be restored on the cellular telephone at a later time as desired, by again connecting the cellular telephone to the computer and transferring the stored information. There are major drawbacks with this approach, however, including the need to both use a computer and install special software. This sometimes requires user sophistication, user motivation and user resources that may match a relatively small percentage of cellular telephone system users. Further, these approaches are not believed to back up the entire user state of contemporary cellular telephones.

Therefore, what is completely lacking in the prior art are wireless mobile communication devices and systems which can migrate the user state from one mobile communication device to another whether voluntary (such as when a new mobile device is purchased) or in a disaster recovery situation. What is also lacking in the prior art are wireless mobile communication devices and systems with disaster recovery which can conveniently restore the user state of a mobile device which has been temporarily impaired or disabled.

### SUMMARY OF THE INVENTION

In view of the aforementioned problems and deficiencies of the prior art, the present invention provides, in a multiple customer subscriber communication system, an information backup and transfer method for wireless, mobile communication devices. The method at least includes: a) maintaining a user state database under the dominion of a control office; b) initiating a communication session at least between a mobile communication device and the control office, the communication session having the capability of at least one separate function from backup or transfer of user state information stored on the mobile communication device; and c) during the communication session established in element b), uploading and storing in the user state database, user state information stored on the mobile communication device.

The present invention also provides a multiple customer subscriber communication system at least including: a plurality of wireless, mobile communication devices; at least one control office; and a user state database under the control of the control office; wherein the mobile communication devices are adapted to engage in a communication session with the control office, the communication session having the capability of at least one separate function from backup or transfer of user state information stored on the mobile communication device; and wherein the mobile communication devices are further adapted to, during the communication session, upload and store in the user state database, user state information stored on the mobile communication device.

The present invention further provides a portable wireless communication device capable of telephonic voice communication for use in a multiple customer subscriber communication system. The communication device at least includes: a receiver adapted to receive communications; a transmitter adapted to transmit communications; a control unit adapted to control the operation of the device; memory adapted to store user state information; a memory interface; a display; an audio reproducer; and an a user input device. The communication device is adapted to engage in a communication session with a control office of the communication system, the control office including a user state database adapted store user state information from wherein the memory is adapted to store user state information from a plurality of subscriber communication devices. During the communication session, the communication device is adapted to upload and storing in the user state database, user state information stored on the communication device.

The present invention additionally provides, in a multiple customer subscriber communication system, a migration method for wireless mobile communication devices at least including: a) providing a user state database adapted to store user state information from a plurality of system mobile communication devices, the database being under the dominion of system control office; b) establishing a communication session between a mobile communication device and the control office; c) at an authorized user's direction, downloading user state information from the user state database to a mobile communication device; and d) within the mobile communication device in c), adopting at least a portion of the downloaded user state.

### BRIEF DESCRIPTION OF THE DRAWING FIGURES

Features and advantages of the present invention will become apparent to those skilled in the art from the description below, with reference to the following drawing figures, in which:

FIG. 1 is schematic diagram of a communication system capable of implementing the present-inventive mobile communication device backup, disaster recovery and migration method, with the method being partially implemented by an Intelligent Network (IN);

FIG. 2 is schematic diagram of a communication system capable of implementing the present-inventive mobile communication device backup, disaster recovery and migration method, with the method being partially implemented by a Mobile Telecommunications Switching Office (MTSO);

FIG. 3 is a schematic block diagram of mobile communication device capable of active operation in the present-inventive backup, disaster recovery and migration method;

FIG. 4 is a flow chart illustrating the present-inventive mobile communication device backup method where a call is placed to a voice mail or message center to initiate the method;

FIG. 4A illustrates several flow charts that supplement the flow chart of FIG. 4 in the case where a current telephone call is interrupted;

FIG. 5 is a flow chart illustrating the present-inventive mobile communication device backup method wherein a conventional call is placed or received to initiate the method;

FIG. 5A illustrates several flow charts that supplement the flow chart of FIG. 5 in the case where a current telephone call is interrupted;

FIG. 6 is a flow chart illustrating the present-inventive mobile communication device backup method wherein a user state update button on the mobile device is activated to initiate the method;

FIG. 7 is a flow chart illustrating the present-inventive mobile communication device disaster recovery and migration method;

FIG. 8 is a flow chart illustrating the present-inventive mobile communication device disaster recovery and migration method with peer-to-peer migration; and

FIG. 9 is illustrates several implementations of the present-inventive mobile communication device backup, disaster recovery and migration system for the case where communication between a mobile communication device and the control office for the purpose of user state backup, disaster recovery or migration operations is via the Internet.

### DESCRIPTION OF THE PREFERRED EMBODIMENTS

Description of the System and Devices

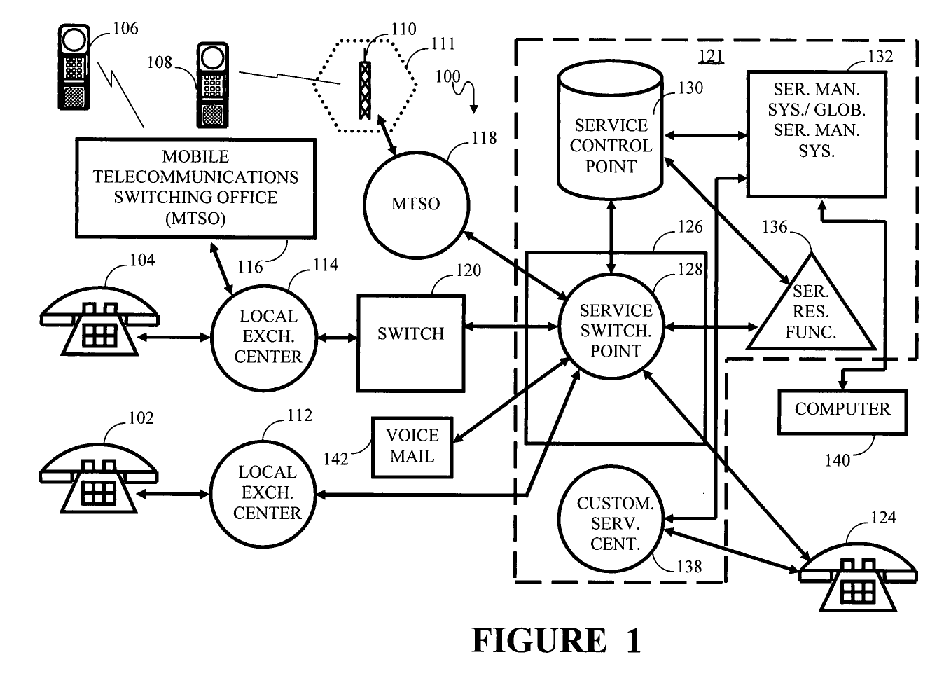

FIG. 1 illustrates a general system 100 capable of implementing the present-inventive backup, migration and disaster recovery methods for wireless, mobile communication devices. In the particular embodiment, part of the functions to be described infra, are carried out by an intelligent network.

The system 100 includes a variety of telephonic input devices as would be common in a general telephone system, such as land line telephones 102, 104 and 124. However, emphasis is placed on the use of wireless mobile telecommunication devices such as the ones 106 and 108. While the current example uses cellular telephones as the wireless communication devices, other types of wireless mobile telecommunication devices can also be used with the present invention. Examples include, but are not limited to, pagers, personal communication services (PCS) devices, and satellite telephones.

A system capable of cellular communication also includes an array of cell towers such as the one 110, each tower facilitating duplex communication of cellular telephone customers within a defined region called a “cell,” such as the one 111. The switching and processing (including signaling and control) of calls within a cellular telephone system and between a Central Office (CO) of a Public Switched Telephone Network (PSTN), is handled by a Mobile Traffic Switching Office (MTSO), such as the ones 116 and 118.

Local exchange centers (LECs) 112 and 114 handle many of the initial calls in the PSTN, and route calls to a switch such as the one 120. The switch 120 finds an efficient route to a stand-alone Service Switching Point (SSP) or a switch 126 integrated with an SSP 128. The SSP is part of an automated, Intelligent Network (IN) 121 that can processes mobile communication calls, as well as device backup, migration and disaster recovery operations.

As shown in the figure, the mobile telephones 106 and 108 connect to the IN 121 via the MTSO or MTSOs 116 and 118. In some cases (as with the MTSO 118) the connection is directly to the IN. In other cases, connection from an MTSO (e.g., 116) is first to an LEC.

Further details about the LECs (112 and 114) and switches (116, 118 and 120) will not be included in this letters patent, given their function and commonplace, as they are easily implemented by those skilled in the art.

The SSP 128 is linked to a Service Control Point (SCP) 130. The SCP 130 has an extensive database storing information of importance, including a user state database according to the present invention. The user state database stores the user states of all subscribers who elect or pay (as a matter of design choice) to have the user states of their wireless portable communication devices remotely backed up by the database.

The SCP 130 performs service logic and provides the SSP 128 with instructions about how to integrate user state backup, migration and disaster recovery operations during telephone calls. It will be appreciated by those skilled in the art that the SCP 130 can be implemented as a networked database, not limited to one geographic location.

After the SCP 130 receives a query from the SSP 128 for a user state-related operation, the SCP instructs the SSP to connect to a Service Resource Functionality (SRF) or an intelligent peripheral (IP) 136 when required. The SRF 136 can be a stand-alone unit or integrated in the switch 126. The SRF prompts the user for, and collects information such as the telephone number (or the mobile identification number MIN in the alternative) or the electronic serial number (ESN) of the device in question when that is not the device currently in communication with the IN. The latter situation includes migration operations to transfer the user state from one mobile communication device to another. The SRF 136 can also prompt the subscriber for and collect access codes such as personal identification numbers (PINs) that are necessary for access to store, modify, or migrate particular user states.

Access to the stored user states can be by the subscriber or by others such as key employees of the cellular telephone carrier/service provider. For example, when a customer purchases or acquires a new cellular telephone or replaces an old or existing one, a key employee can enter a master access code to initiate a migration operation.

Failing entry of the correct PIN necessary to access a stored user state or initiate a migration, etc., the IN transfers the call to an Operator Service System (OSS) or customer service center 138 to connect the caller to a carrier's telephone operator as part of a bailout procedure.

After the PINs have been matched, the SRF 136 gives the customer a menu of options and prompts the customer to choose an operation which can be triggered by entering an alphanumeric sequence. Such options might include: creating a new stored user state; updating an existing user state; performing a migration operation of the stored user state to a target wireless, mobile communication device; opting out of stored user state services; changing the access code(s); etc. Upon receiving the initial choice from the menu, the SRF 136 can also request other information such as the mobile identification number (MIN) or electronic serial number (ESN) of the device to which the user state is to be transferred for migration operations. During set up of the user state backup service (and later as desired) the customer can set the parameters of exactly which portions of the user state are to be remotely stored and the manner in which backup will occur.

A related feature of the present invention allows for user state uploads to occur when the subscriber is connected to a voice mail message center, or when the customer activates a special key or keys on the keypad of the communication device when the device is in standby mode or automatically during specified times during standby mode, or when a key or keys are activated or when it is time for a scheduled user state update during a conventional telephone call. The user state information can be transferred in special intact packets, or interleaved with other information to be transferred during a communication session. For quality considerations, user state update information might be transferred during lulls in information exchange for the case where the information is uploaded during the occurrence of a typical telephone call.

It should be pointed out that while the present invention may be better suited for digital communication systems, those skilled in the art will be able to implement the present invention in analog communication systems.

In one embodiment of the present invention, a Service Management System (SMS) or Global Service Management System (GSMS) 132 is employed to provision the subscribers' user state storage and migration service. The system subscriber can change or modify the provisioning of the operational information associated with his/her account by 1) telephoning the IN 121 (SSP/SCP), or by 2) connecting to the SMS/GSMS via the customer service center, or by 3) connecting to the SMS/GSMS with a desktop computer, network computer, or the like (140).

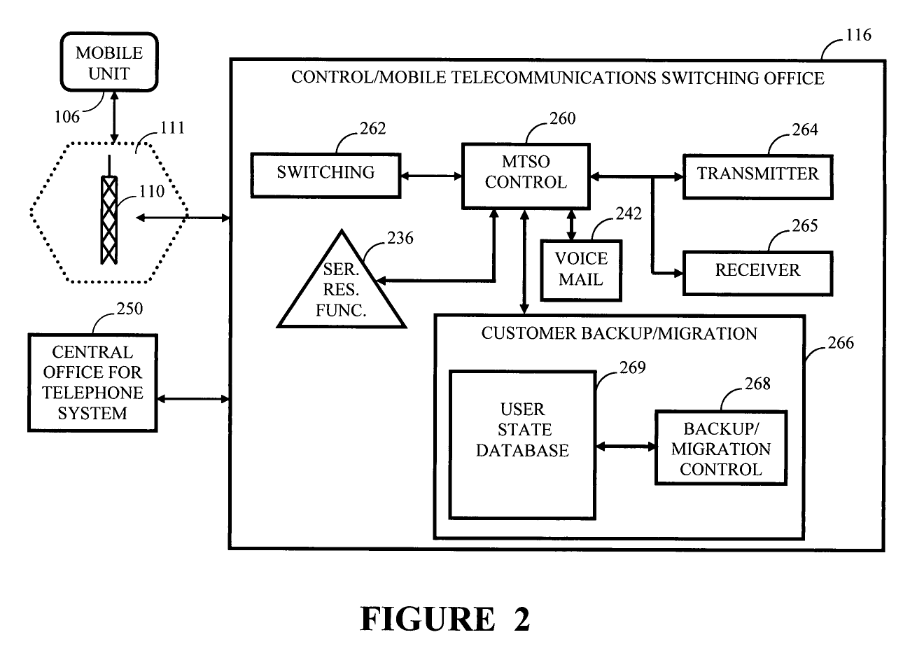

FIG. 2 illustrates further details of an MTSO according to the present invention. In the embodiment illustrated by FIG. 2, the MTSO carries out the user state update and migration functions without the necessity of an intelligent network. Used in the claims and throughout this letters patent, the term “control office” is used generally to denote the instrumentality in the communication system which maintains and updates user states for system subscribers, and which migrates user states (or portions thereof) to mobile communication devices designated by authorized system subscribers and system administrators. In the preferred embodiment, the control office also subsumes the system MTSO.

Several mobile units such as the one 106 can engage in duplex communication with cell towers such as the one 110. In the example shown, the tower principally covers a cell area 111. The cell tower 104 is also in communication with, and under the control of the MTSO 116. Communication with the rest of the PSTN is via a Central Office 250.

The MTSO 116 nominally includes an MTSO Control Unit 260, telephone switching circuitry (or switching unit) 262, a transmitter 264, a receiver 265, a voice mail function (or message center) 242, a Service Resource Functionality (SRF) 236, and a customer backup and migration element 266. The Control Unit 260 controls the overall operation of the MTSO, while the switching unit 262 handles the telephone switching functions of the MTSO under the direction of the control unit. The transmitter and receiver (264, 265) function to communicate with other components of the cellular telephone system, and with the PSTN in general. As with the previous example of FIG. 1, the SRF 236 is an intelligent peripheral which prompts a user for and collects needed information and codes.

The customer backup and migration element 266 contains a user state database 269 which may be in one physical location, or several networked physical locations. Control of operations involving user states and the user state database is handled by a backup/migration control element 268.

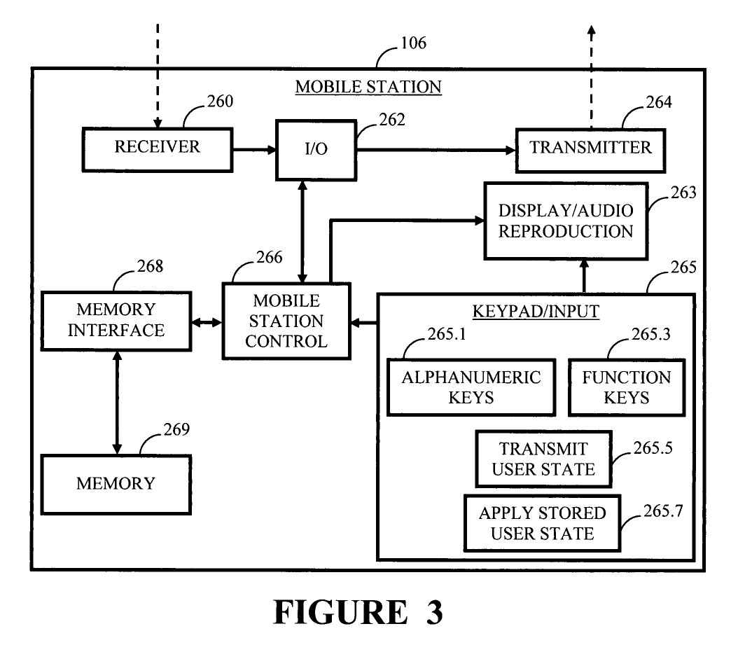

FIG. 3 is an example of a wireless mobile communication device 106 capable of functioning within the present-inventive system for remotely storing and updating communication device user states, and for downloading and implementing migrated user states. A receiver 260, transmitter 264 and an input/output device 262 connected between, all function in a manner well known to those skilled in the art to which the present invention pertains. A mobile station control 266 controls the overall operation of the mobile communication device. The mobile communication device 106 also contains a keypad/input unit allowing a user to input alphanumeric information (via alphanumeric keys 265.1), as well as to activate various functions (via function keys 265.3) of the communication device. The mobile communication device 106 also contains memory 269 for storing data, applications, and other information, including information pertaining to the current user state of the mobile communication device. As a matter of design choice, previous versions of the user state or portions of previous user states can also be stored in much the same manner that a computer may be restored to previous states (or at least portions of previous states). In the same vein, the remotely stored user states can include the most up-to-date versions, as well as previous versions as a matter of design choice.

A memory interface 268 manages the storage of information in the memory 269, and is capable of inventorying memory information and bundling the information in a convenient format to represent the user state of the mobile communication device for presentation to mobile station control and the remote user state database as needed. In alternate embodiments, the memory interface 268 may function simply as a memory manager or the like, and the additional functions described supra can be carried out by the mobile station control 266 or other means. Those skilled in the art will appreciate that a standard data synchronization protocol is advantageous for moving device information between many different types of portable communication devices. The SyncML protocol developed through the Open Mobile Alliance is one possible protocol which may be used with the present invention.

Returning to the keypad/input unit 265, additional keys can activate a one key/one step function (via key 265.5) for uploading the user state to the remotely located user state database, or cause the a stored user state to be applied to the mobile communication on demand (via key 265.7).

The mobile communication device also contains conventional audiovisual reproduction means (e.g., one or more speakers and one or more displays) 263.

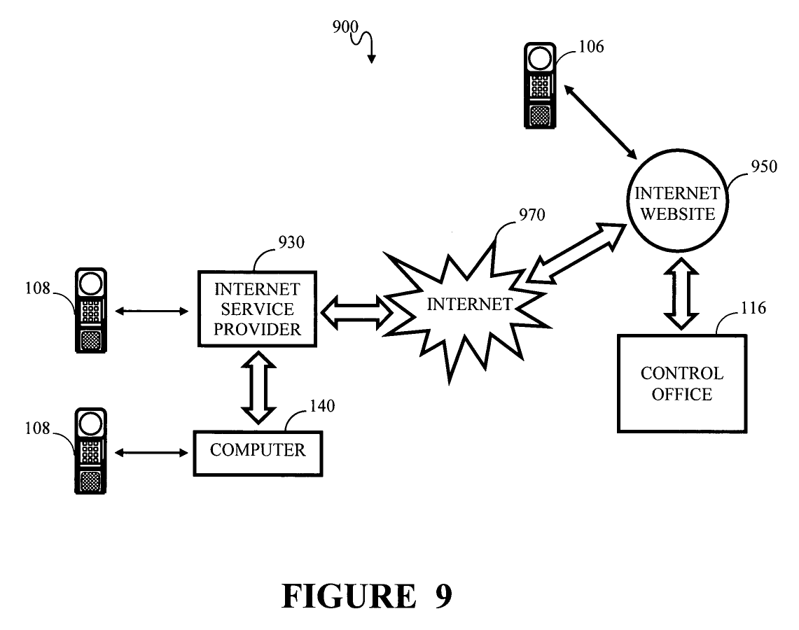

FIG. 9 illustrates a web-based system 900 capable of centralized backup and update of user state information, as well as the migration of user state information. Access to the control office 116 for user state backup, updating and migration is via an Internet website 950 under the dominion of the control office entity. Using this general approach, several methods of communication between a mobile communication device (e.g., 106, 108), can occur. These included communicating directly with website, if the mobile communication device is capable, communicating with an Internet Service Provider (ISP) 930, which in turn connects the device to the website 950 via the Internet 970, and connecting the mobile communication device to a computer 140, which communicates with the website 950 through an ISP and through the Internet. This provides for a versatile, convenient system with several approaches to communication between the mobile communication devices and the control office for the purpose of user state storage, updating, or migration.

Description of the Methods/Algorithms

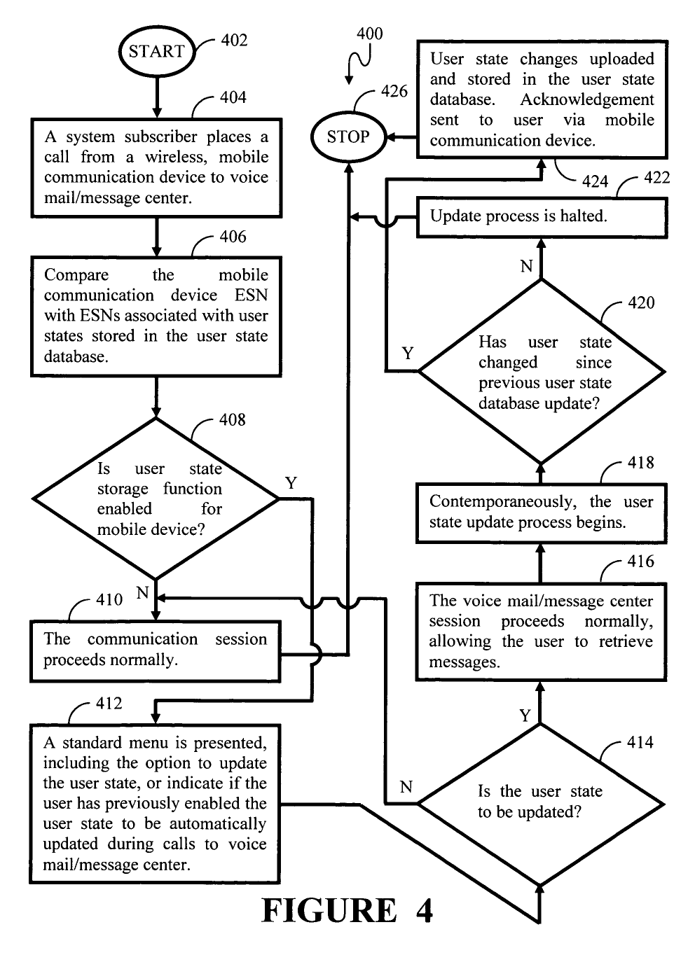

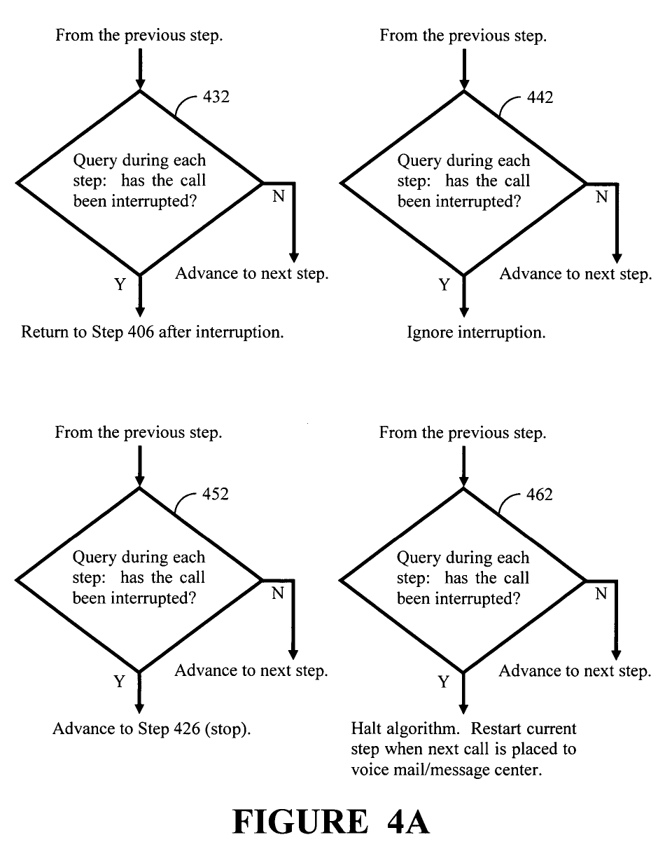

A first embodiment for a method according to the present invention is illustrated in the algorithm 400 of FIG. 4.

After the start (Step 402) of the algorithm, a system subscriber places a call from a wireless, mobile communication device to a voice mail/message center (Step 404). The control office (which may be subsumed by an MTSO, or other portion of the communication system, such as an intelligent network as described supra) compares the ESN of the of the mobile communication device being used to the ESNs associated with the user states stored (or at least enabled for storage) in the user state database (Step 406). As a result of the comparison in Step 406, the algorithm determines whether the currently used communication device has a user state stored in the user state database (Step 408).

If the remote user state storage function has not been activated for the device in question, the communication session proceeds normally (Step 410, followed by Step 426 when the communication session ends), without any operations related to user state storage, update or migration. Normal procession may include retrieving voice mail, for example. If the remote user state storage function has been activated for the device in question, a menu of choices is presented to the user in Step 412. This may include prompts providing the user with the opportunity to begin a user state update process, or a user state migration process. If the user has previously activated an automatic update feature, the user may be notified of that previous choice, and notified that the user state of the device in communication is currently being automatically uploaded contemporaneously with the voice/message retrieval process.

For example, the following messages might be announced to the user during the session: “The last time you backed up the information stored on your telephone including the unique information representing your user personality was ______. Would you like to back up the current state of your telephone now?” Or, “You have two new messages. You have also previously indicated that you would like to backup up your telephone personality information. Choose ‘1’ if you would like to listen to your voice mail and also backup the current state of your telephone, ‘2’ if you would like to retrieve your voice mail only, ‘3’ if you would like to backup the current state of your telephone only, ‘4’ . . . , and ‘5’ to exit.”

A subscriber may also set up the user state storage and maintenance parameters such that the user state (or user state changes) is automatically uploaded to the user state database for storage during a call to voice mail (or during other communications as a matter of design choice), without the need to announce in an overt way that an update is occurring. In this approach, the user state update operation can appear to be seamless from the user's point of view.

If no user state update is to occur the algorithm returns to Step 410 for normal message retrieval, etc. (Step 414). If a user state update is to occur, however, then the retrieval of messages occurs along with updating/uploading the user state (Steps 414, 416 and 418).

In the preferred embodiment of the algorithm 400, once an initial user state is stored, only changes to the user state are stored during updates. This has the effect of reducing memory and other resource requirements needed for a system which may have a large customer base. However, periodically, the entire current user state may be stored to supersede previous stored user states and their associated updates. In keeping with the foregoing, Step 420 determines whether any changes to the user state of the mobile device have occurred since the previous update session. If so, changes since the previously stored user state are stored in the user state database, and an acknowledgement is sent to the mobile communication device (Step 424). The acknowledgement can take many forms, including an audio or text message, or an audio or visual indication displayed by the mobile device. If no changes occurred to the user state since it was last updated in the user state database, the update process is halted, followed by an end of the algorithm (Steps 422 and 426.

It should be understood that the baseline user state is combined with changes to the user state to recreate the current status of a user state in the preferred embodiment.

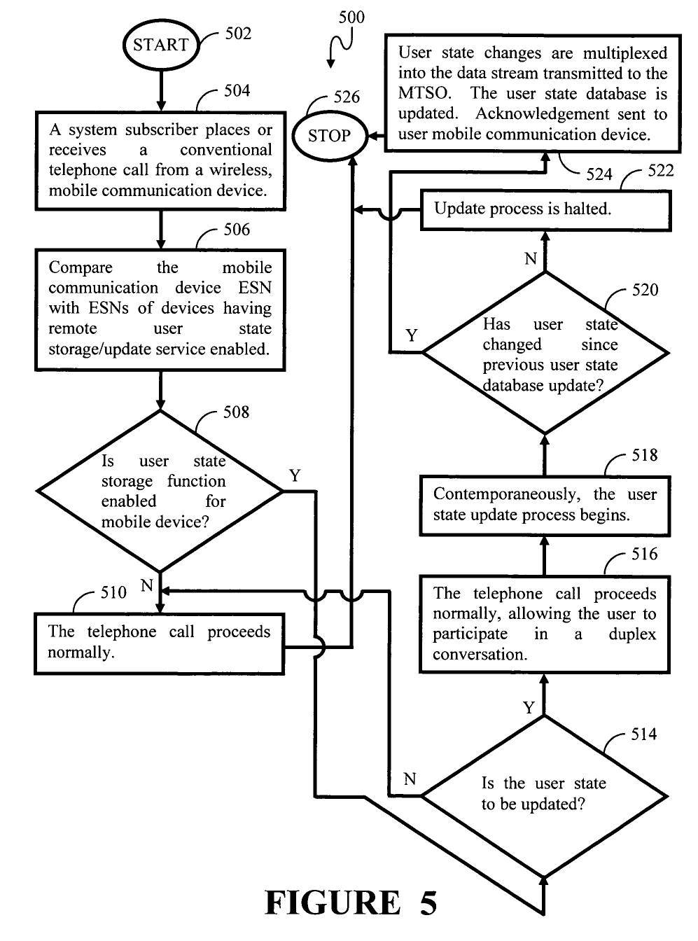

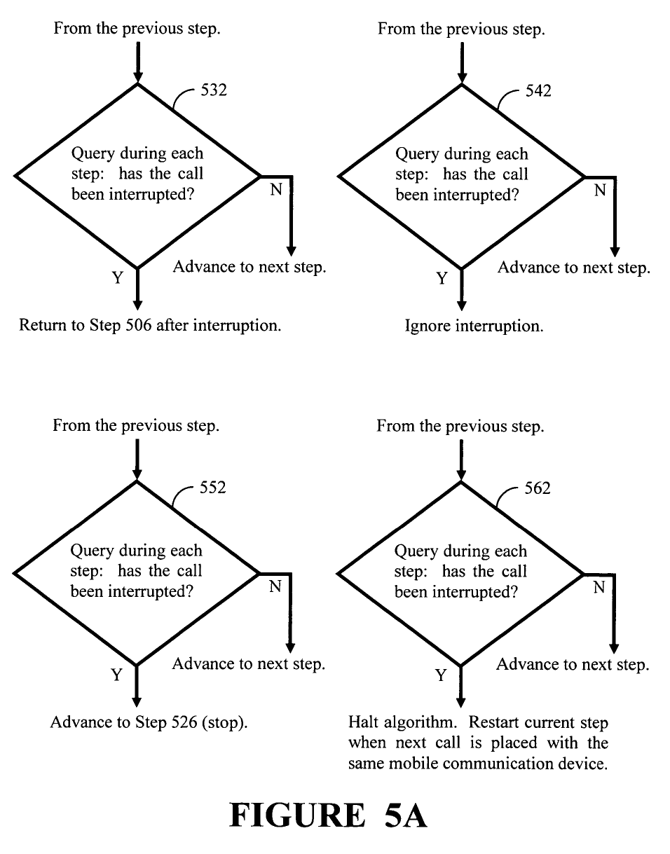

Another approach is illustrated via the algorithm 500 in FIG. 5. After the start (Step 502), a system subscriber places or receives a conventional telephone call from a wireless, mobile communication device (Step 504). The next step (506) compares the wireless device's ESN with the ESNs of system devices for which the remote user state storage and update feature has been enabled. If the user state storage and update feature is not active for the device, the telephone call is processed normally, without the addition of user state storage or update activity (Steps 508 and 510). The algorithm stops in Step 526. If however, the user state storage and update feature is active for the device, the system determines whether the remotely stored user state is to be updated (Step 514).

If the user state is not to be updated, the algorithm reverts to Step 510, processing the call normally without user state update. If the user state is to be updated, the telephone call proceeds normally (Step 516), and the user state update process begins contemporaneously (Step 518). If the user state has not changed since the previous update session, the update process is halted to prevent storing redundant information (Steps 520 and 522). If the user state has changed since the last update session (or if a predetermined amount of time has expired since the last update in an alternate embodiment) the algorithm advances to Step 524, where the mobile device multiplexes the user state update information into the data stream transmitted to the MTSO, and the MTSO sends an acknowledgement signal back to the device when the update process is complete.

Before the user state update processes of FIGS. 4 and 5 are complete, it is possible that the current telephone call or communication session could be interrupted. FIGS. 4A and 5A provide some of the different approaches that may be followed when such interruptions occur. A general approach is to constantly query whether the call has been interrupted (Steps 432, 442, 452 and 462 in FIG. 4A, and Steps 532, 542, 552 and 562 in FIG. 5A). Possible responses to the call interruption include (but not limited to) returning the algorithms to Steps 406 or 506 (to restart most of the algorithm steps), ignoring the interruption, advancing the algorithms to Steps 426 and 526 (to stop the algorithms), and temporarily halting the execution of the algorithms. If the latter approach is taken (temporarily halting), the algorithm step occurring during the call interruption is restarted after either the next call to the voice mail/message center is placed from the same mobile communication device (for the algorithm 400), or when the next telephone call is place from the same mobile communication device, regardless of the call recipient (for the algorithm 500).

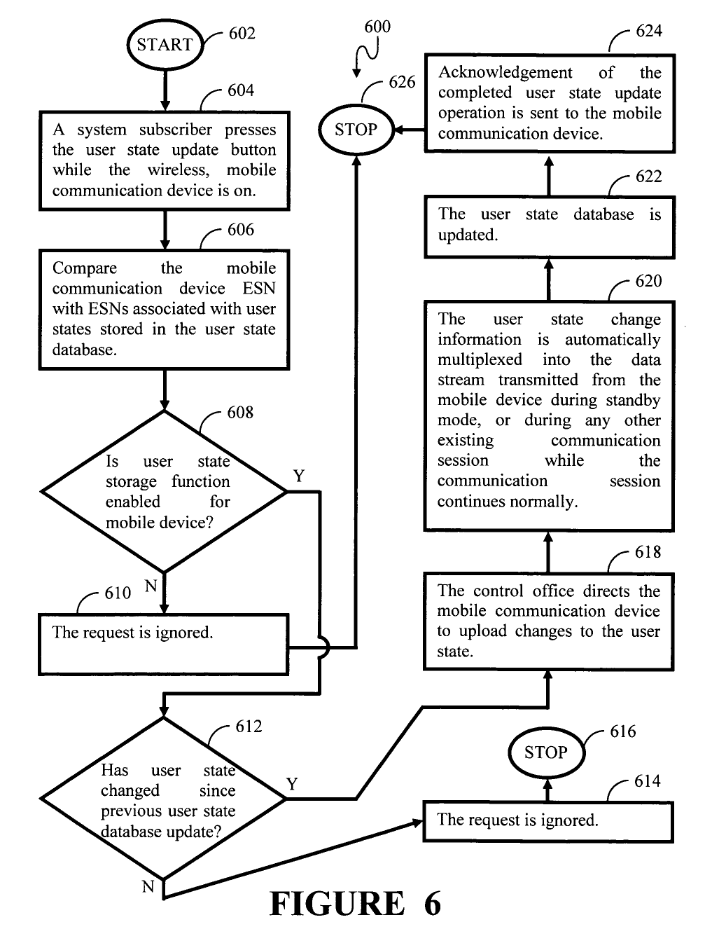

Another approach illustrated by the algorithm 600 in FIG. 6 allows a device user to upload user state information on demand after the start of the algorithm (Step 602), by pressing a special function key or keys on the device keypad (Step 604). The control office compares the device ESN with the ESNs of devices which have the remote user state storage and update feature enabled (Step 606). If the user state storage and update feature is not enabled for the device, the request is ignored (Steps 608 and 610), followed by the end of the algorithm (Step 626). If the user state storage and update feature is enabled for the device, the algorithm jumps to Step 612 to determine whether the user state has changed since the previous update session.

If the user state has not changed since the previous update session, the request to remotely store user state updates is ignored (Step 614), followed by the end of the algorithm (Step 616). If the user state has changed since the previous update session, the control office directs the mobile device to upload the user state change information (Step 618). In Step 620 the mobile device multiplexes the user state change information into the data stream it transmits during standby mode or during any other existing communication session while the communication session continues normally.

The standby mode can be broadly described as the mode of a mobile communication device when the device is in communication with the control office and capable of receiving or transmitting calls or other communication from or to third parties. This includes, for example, the state of a cellular telephone after power up, self diagnostics, and communication between the mobile and the cell tower and MTSO generally referred to as “registration” in some systems.

In an alternate embodiment, the system can be programmed to allow a subscriber to have user states automatically updated during standby modes. In such update operations, the updating process may be automatically halted when an incoming call is received if system resources are inadequate to permit simultaneous handling of both the telephone call and the user state update operation. The update operation may also be halted by the user either on demand, or automatically when the placing a call where resources are inadequate to handle both the call and the update operation.

Returning to the algorithm 600, the user state database is updated in Step 622. This is followed by the control office sending an acknowledgment signal to the mobile device in Step 624, and the end of the algorithm (Step 626).

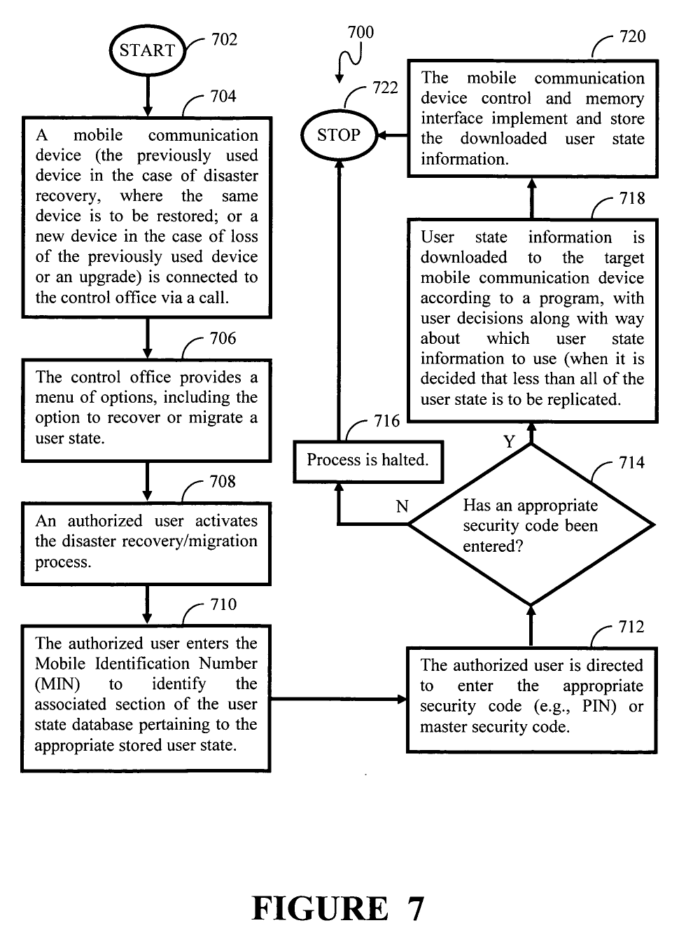

A general user state migration and implementation process is illustrated via the algorithm 700 in FIG. 7. After the start (Step 702) of the algorithm, a target mobile communication device (the previously used device in the case of disaster recovery, where the same device is to be restored; or a new device in the case of loss of the previously used device or an upgrade) is connected to the control office via a call (Step 704). The control office provides a menu of options to the authorized user, including the option to recover or migrate a remotely stored user state (Step 706).

The authorized user activates a disaster recovery or migration process (Step 708) and then enters the Mobile Identification Number (MIN) or ESN to identify the user state stored in the user state database that is to be migrated (Step 710). As a safeguard, the user must then enter the correct security code (Step 712). Without the correct security code the recovery/migration process and the algorithm are halted (Steps 714, 716 and 722). Entry of the correct security code in Step 718 causes the user state information to be downloaded to the target mobile communication device according to a program, with user decisions along the way about which user state information to use (when it is decided that less than all of the user state is to be replicated).

The mobile communication device control and memory interface store and implement the downloaded user state information in Step 720 to complete the migration process. Implementation of the user state information includes such actions as changing the device settings to comport with the downloaded user state information, storing downloaded directory information, changing the device profile to comport with the downloaded user state information, storing the audio and visual information to be replicated according to the downloaded user state information, and storing applications and statuses of applications according to the downloaded user state information, to name a few.

For increased system security, an employee or other agent of the entity operating the control office can have the authority to transfer user state information from one mobile communication device to another when directed by an authorized customer, while being unable to view the contents of the stored or transferred user state information.

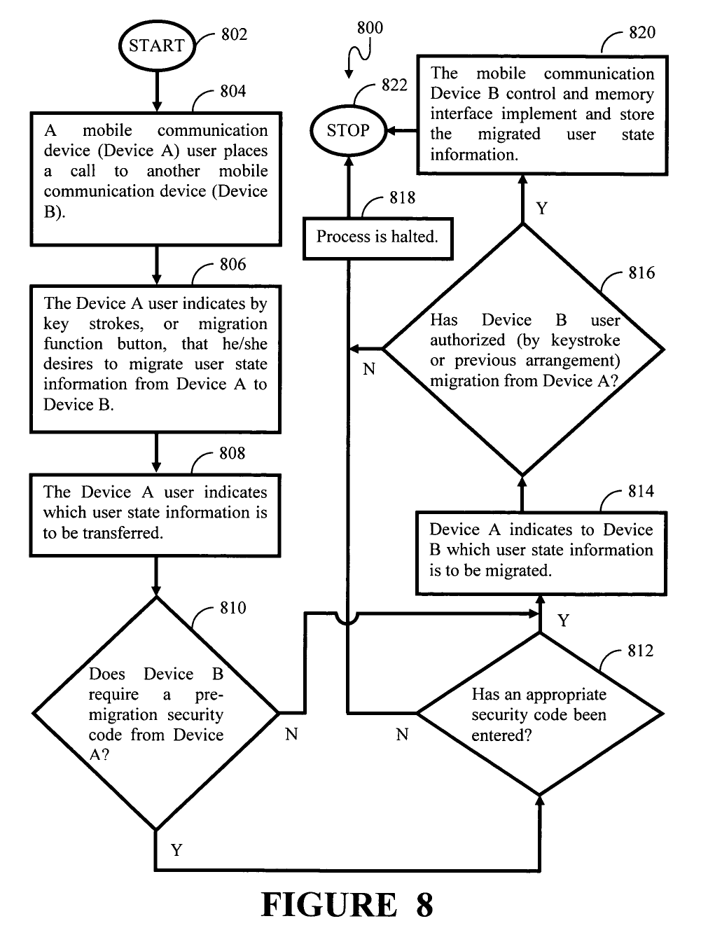

An alternate user state migration and implementation process is illustrated via the algorithm 800 in FIG. 8. This is a peer-to-peer migration process for directly migrating user state information from one mobile communication device to another communication device. That is, the user state information is not downloaded from a remote user state database, but rather directly from a source mobile communication device in communication with the target mobile communication device.

After the start (Step 802) of the algorithm, a call is placed from a source mobile communication device (“Device A”) to a target mobile communication device (“Device B”) in Step 804. The call may be a conventional communication session or a special call for migration only.

Next, the Device A user indicates by keystrokes, or by activating a special migration key, that he/she desires to migrate user state information from Device A to Device B. In the preferred embodiment, the Device A user also indicates in Step 808, the portion of the Device A user state to be migrated (if less than all of the user state is to be migrated). Also in the preferred embodiment, the migration process in the algorithm 800 is menu driven to make it user-friendly.

If the mobile communication Device B requires the transmission of an appropriate security from Device A, this is so indicated in Step 810, whereupon the algorithm advances to Step 812. If not, the algorithm jumps to Step 814. Step 812 determines whether the appropriate security code has been transmitted. The transmission of an appropriate security code advances the algorithm 800 to Step 814, while an inappropriate security code (or no security code where one is required) causes the algorithm 800 to jump to Step 818, where the attempted migration processes is halted.

In Step 814, mobile communication Device B is presented with the user state information to be migrated. If the mobile communication Device B user has authorized the migration, Device B receives and implements the migrated user state information (Steps 816 and 820). Without authorization, the algorithm 800 is halted (Steps 816 and 818). Authorization can take place during the current call by making the appropriate pre-defined keystroke or keystrokes on Device B. It should be appreciated by those who are skilled in the art to which the present invention pertains, that a single user can control the operations of both mobile communication Device A and mobile communication Device B where the two devices are in close proximity.

Variations and modifications of the present invention are possible, given the above description. However, all variations and modifications which are obvious to those skilled in the art to which the present invention pertains are considered to be within the scope of the protection granted by this Letters Patent.

As an example, the user state information can be in the form of device profile information with unique user state information pertaining to a particular device, and entity profile information with user state information pertaining to devices of users who are affiliated with a particular entity or group. For example, employees of a particular company may have certain portions of their mobile communication device user states that are in common, while other portions are individualized for a particular device. This allows migration and restoration processes to be flexible so that an entity profile can be stored on each new mobile communication device acquired by an employee, but a communication device can be personalized by storing thereon, a previous person profile.

Entities and groups can include, employers, organizations and other groups, families, and designated friends, to name a few.

What is claimed is:

1. In a multiple customer subscriber communication system, an information backup and transfer method for wireless, mobile communication devices comprising:
a) maintaining a user state database under the dominion of a control office;
b) initiating a communication session at least between a mobile communication device and the control office, said communication session having the capability of at least one separate function from backup or transfer of user state information stored on said mobile communication device; and
c) during the communication session established in element b), uploading and storing in the user state database, user state information stored on said mobile communication device.

2. The method of claim 1, wherein element b) further comprises during said communication session, initially connecting said mobile device via a telephone call to a voice mail function.

3. The method of claim 1, wherein said communication session is a conventional telephone call with at least two calling parties, and said user state information is uploaded within the data stream transmitted from said mobile communication device to said control office.

4. The method of claim 1, further comprising:
automatically updating the user state database with updated user state information from a mobile communication device while the mobile communication device is engaged in a communication session initialized in element b);
wherein said communication session comprises a standby mode.

5. The method of claim 1, wherein said user state comprises telephone directory information stored on said mobile device.

6. The method of claim 1, wherein said user state comprises settings of the mobile communication device.

7. The method of claim 1, wherein said user state comprises telephone call history information stored on said mobile device.

8. The method of claim 1, wherein said user state comprises text messages stored on said mobile device.

9. The method of claim 1, wherein said user state comprises scheduled event information stored on said mobile device.

10. The method of claim 1, wherein said user state comprises information pertaining to the state of applications executed by said communication device.

11. The method of claim 1, further comprising:
for each user having a user state stored in said user state database, establishing a security access code required for accessing a stored user state.

12. The method of claim 1, further comprising:
d) upon direction of an authorized party, downloading user state information pertaining to a first mobile communication device to a second communication device;
e) storing user state information pertaining to said first mobile communication device on said second mobile communication device; and
f) causing said second mobile communication device to adopt at least a portion of the user state information pertaining to said first mobile communication device.

13. The method of claim 12, further comprising:
implementing elements d), e) or f), when the user of said second mobile communication device authorizes implementation; and
foregoing elements d), e) or f), when the user of said second mobile communication device has not authorized implementation.

14. A multiple customer subscriber communication system comprising:
a plurality of wireless, mobile communication devices;
at least one control office; and
a user state database under the control of said control office;
wherein said mobile communication devices are adapted to engage in a communication session with said control office, said communication session having the capability of at least one separate function from backup or transfer of user state information stored on said mobile communication device; and
wherein said mobile communication devices are further adapted to, during said communication session, upload and store in the user state database, user state information stored on said mobile communication device.

15. A portable wireless communication device capable of telephonic voice communication for use in a multiple customer subscriber communication system, said device comprising:
a receiver adapted to receive communications;
a transmitter adapted to transmit communications;
a control unit adapted to control the operation of said device;
memory adapted to store user state information;
a memory interface;
a display;
an audio reproducer; and
an a user input device;
wherein said communication device is adapted to engage in a communication session with a control office of said communication system, said control office subsuming a user state database adapted store user state information from wherein said memory is adapted to store user state information from a plurality of subscriber communication devices; and
wherein during said communication session, said communication device is adapted to upload and storing in the user state database, user state information stored on said communication device.

16. In a multiple customer subscriber communication system, a migration method for wireless mobile communication devices comprising:
a) providing a user state database adapted to store user state information from a plurality of system mobile communication devices, said database being under the dominion of system control office;
b) establishing a communication session between a mobile communication device and said control office;
c) at an authorized user's direction, downloading user state information from said user state database to a mobile communication device; and
d) within the mobile communication device in c), adopting at least a portion of the downloaded user state.

17. In a multiple customer subscriber communication system, an information transfer method for wireless, mobile communication devices comprising:
initiating a communication session via said system, at least between a mobile communication device and a second communication device;
during said communication session, transferring from said mobile communication device to said second communication device, at least a portion of replicated user state information stored in the memory of said mobile communication device; and
storing in the memory of said second communication device, at least a portion of replicated user state information received from said mobile communication device.

18. The method of claim 17, further comprising
during said communication session, transferring from said second communication device to said mobile device, at least a portion of replicated user state information stored in the memory of said second communication device; and
storing in the memory of said mobile communication device, at least a portion of replicated user state information received from said second communication device.

19. The method of claim 1, wherein said user state information is common to a group of communication device users affiliated with an identified entity.

20. The method of claim 1, wherein said user state information comprises specific communication device user state information from specific communication devices, and entity communication device user state information related to aspects of user states common to an entity to which a group of communication device users is affiliated.

21. The method of claim 20, wherein said entity is an employee, and said communication device user is an employee of said entity.

22. The method of claim 20, wherein said entity is a family, and said communication device user is a member of said family.

23. The method of claim 20, wherein said entity is a group of designated friends.

24. The method of claim 1, further comprising:
carrying out said communication session via connecting to an Internet website under the dominion of said control office.
